(19) United States
(12) Patent Application Publication
(10) Pub. No.: US 2004/0169122 A1
(43) Pub. Date: Sep. 2, 2004

(54) Seal apparatus

(76) Inventors: Alec G. Dodd, Derby (GB); Colin J. Burford, Derby (GB)

Correspondence Address: MANELLI DENISON & SELTER, 2000 M STREET NW SUITE 700, WASHINGTON, DC, 20036-3307, US

(21) Appl. No.: 10/684,491

(22) Filed: Oct. 15, 2003

(30) Foreign Application Priority Data
Oct. 26, 2002 (GB) 0224962.1

(51) Int. Cl. F16M 1/00

(52) U.S. Cl. 248/674

(57) ABSTRACT

A seal for a gas turbine engine comprises an internal abradable lining and two interconnecting flanges. The flanges form a U-shaped channel therebetween for the insertion of radially inwardly directed features on the inner ends of a plurality of stator vanes. One or both flanges support the abradable lining via a land.

This invention relates to support means for a component of a seal. More particularly but not exclusively this invention relates to support means for labyrinth seals for use in gas turbine engines.

A labyrinth seal is defined by an outer annular land supporting a number of annular fins formed on its outer surface, the fins being surrounded in close spaced relationship by a further annular land, the inner surface of which has an abradable lining. In use the inner and outer lands are mounted on relatively rotating components between which a seal is formed.

In gas turbine engines labyrinth seals are commonly used to provide sealing between a stationary stage of stators or guide vanes and a shaft upon which the rotating compressor or turbine blades are mounted. The finned portion of the seal is mounted on the shaft and thus fins of the labyrinth seal cooperate with the abradable lining which is non-rotatably attached or supported by an adjacent portion of a fixed stage of stators or guide vanes. The abradable lining generally comprises a honeycomb structure.

It is known to attach the abradable lining portion of the seal to an annular flange which extends axially in an upstream direction from a portion of the base of a radially inwardly directed ring. The inner ends of the stator or guide vanes are formed with radially inwardly extending members which fit within a slot formed within a retaining ring and are retained therein. Such rings are normally produced as forged rings.

Forged rings, however, are expensive to manufacture and there is a requirement for a cheaper and/or improved alternative to this arrangement.

According to the present invention there is provided support means for a seal for a gas turbine engine, one component of which comprises an annular land having an internal abradable lining and at least two radially, separately formed, outwardly extending members defining flanges, at least one of said members being adapted to support said internal abradable lining, the flanges being adapted and shaped to cooperate with one another so as to form a channel therebetween and said channel being shaped so as to receive one or more connecting members extending radially inwardly from the inner ends of a plurality of stator vanes.

Preferably the or each member which is adapted to support said lining comprises an axially extending portion supporting said abradable lining and a radially outwardly extending portion fixed to a radially outwardly extending portion of the other of said flanges wherein at least one of said flanges is formed such that said U-shaped channel is located radially outwardly from the point of connection of said flanges.

Preferably said members each comprise a convoluted pressed sheet formed from metal or metal alloy.

Preferably said members are brazed together. Preferably both of said members are similarly shaped so as to form said channel.

Preferably a number of angularly spaced pairs of pins are provided and span said channel, said pins being fixed by their ends in the walls of the groove and the pins being spaced from one another by a distance which enables the insertion therebetween of said interconnecting member.

Embodiments of the invention will now be described by way of example and with reference to the accompanying drawings in which:

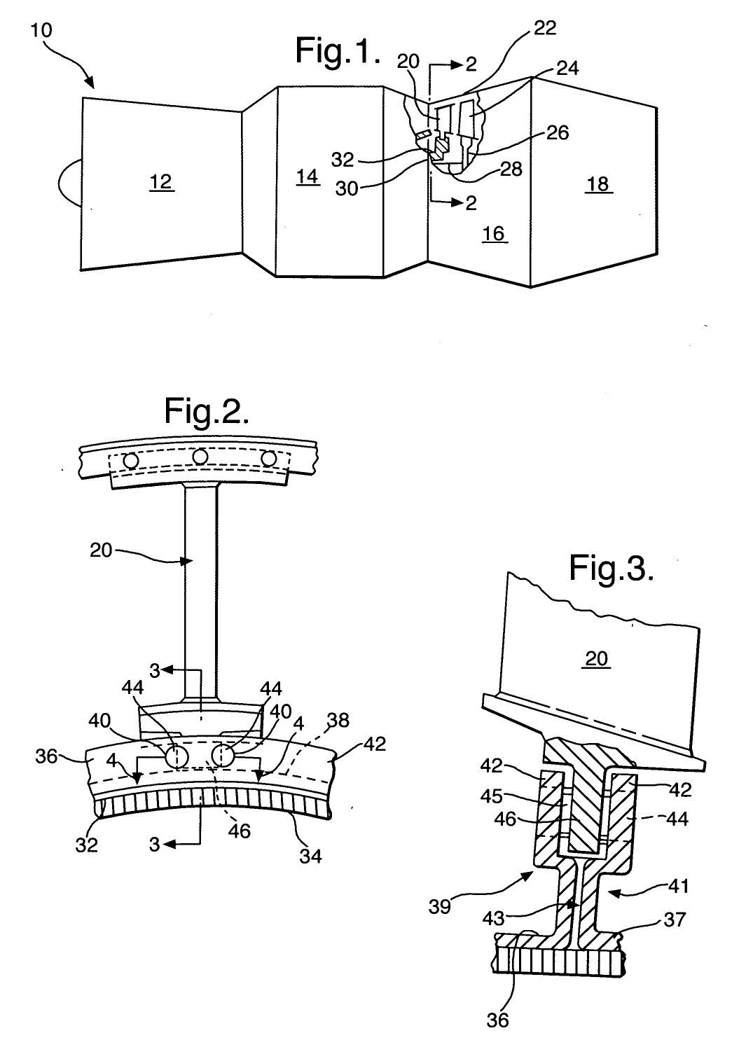

FIG. 1 is a diagrammatic view of a gas turbine engine incorporating an embodiment of the present invention;

FIG. 2 is an enlarged view on line 2-2 of FIG. 1;

FIG. 3 is a view on line 3-3 of FIG. 2;

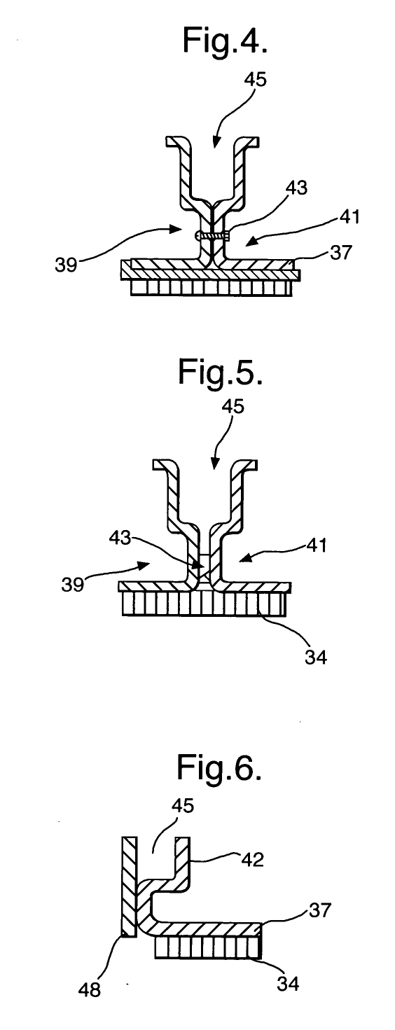

FIGS. 4 to 6 depict further embodiments of the invention.

Referring to FIG. 1 a gas turbine engine 10 includes a compressor 12, combustion equipment 14, a turbine section 16 and an exhaust section 18, all arranged in flow series.

The turbine section has at least one stage of guide vanes 20 affixed in known manner by their radially outer ends, to structure within the engine turbine casing 22. A stage of rotatable turbine blades 24 is positioned immediately downstream of the or each stage of guide vanes 22, again in a known manner.

The turbine blades are mounted on a disc 26 having an annular land 28 bolted to its upstream face, the land extending forwardly and terminating radially inwardly of the guide vanes 20. The portion of the land 28 which lies adjacent the guide vanes 20 has an annular series of radially extending fins 30 formed on its outer surface in known manner and these are surrounded in close spaced relationship by a further annular land 32 mounted on a portion of the stator structure which has an abradable lining (not shown in FIG. 1) on its inner surface, again in known manner. The fins 30 and the abradable lining on the land 32 cooperate to form a labyrinth seal.

Referring now to FIGS. 2 and 3. In accordance with the present embodiment of the invention the land 32 is defined by base portions 36 and 37 of a pair of shaped components 39 and 41 formed from pressed sheet metal or alloy. Each of the components extends radially outwardly to define respective flanges 42. The flange 42 on the component 39 is displaced axially at its radially outer end in a downstream direction and the outer end of flange 37 is similarly displaced in an upstream direction. The outer ends of the flanges are therefore spaced apart to define a channel 45 therebetween.

The flanges are connected together at 43 by any suitable method such as brazing or riveting as shown for example in FIG. 4.

The components 39 and 41 which together define channel 45 are formed from a pressed sheet metal or other suitable material. Good stiffness characteristics are achieved by this angular sheet shape together with light weight, which is lighter characteristics than previous proposals, such as forged rings. This arrangement also provides higher damping and has integral anti-frettage properties.

A plurality of equi-angularly spaced pairs of holes 40, only one pair of which is shown in the drawings, are drilled through the flanges 42 of the groove 38 and a pin 44 is fitted in each hole. It is intended that the pins 44 should stay in situ until their replacement through wear is necessitated. They may thus be a press fit or may be brazed via their ends to the groove walls 42, or both.

The pins 44 of each pair are spaced apart one from the other by a distance which will allow the insertion between them of a foot 46 which projects radially inwardly from the underside of each of the respective guide vanes 20. The number of pairs of pins 44 thus equals the number of guide vanes 20 in the stage.

Each guide vane 20 is affixed via its outer end to fixed engine structure in known manner. Consequently, during operation of the engine 10, who the guide vanes 20 become heated, they expand radially inwardly towards the engine axis. Conversely the land 32 and its associated channel forming components 39 and 41. The fins 30 and the abradable lining 34 then cooperate to form a labyrinth seal.

FIG. 6 shows an embodiment of the invention where only one of the flanges is of pressed sheet form and the adjacent adjoining flange 48 being substantially planar. In this case the abradable lining is carried by the component 41 alone, the component 48 serving merely to cooperate with the displaced flange 42 of the component 41 to define the channel 45.

We claim:

1. Support means for a seal for a gas turbine engine, one component of which comprises an annular land having an internal abradable lining and at least two radially, separately formed, outwardly extending members defining first and second flanges, at least one of said members being adapted to support said internal abradable lining, the flanges being adapted and shaped to cooperate with one another so as to form a channel therebetween and said channel being shaped so as to receive one or more connecting members extending radially inwardly from the inner ends of a plurality of stator vanes.

2. Support means for a seal as claimed in claim 1 wherein said first member flange comprises an axially extending portion supporting said abradable lining and a radially outwardly extending portion fixed to a radially outwardly extending portion of said second member wherein at least said first member is formed such that a radially extending U-shaped channel is formed radially outwardly from the region of connection of said members.

3. Support means for a seal as claimed in claim 1 wherein said members each comprise a convoluted pressed sheet.

4. Support means for a seal as claimed in claim 1 wherein said members are brazed together and both shaped so as to define an annular groove.

5. Support means for a seal as claimed in claim 1 wherein a number of angularly spaced pairs of pins are provided and span the annular channel, said pins being fixed by their ends in the walls of the channel and the pins being spaced from one another by a distance which enables the insertion therebetween of an inwardly directed feature on the inner ends of a plurality of stator vanes associated therewith.

6. Support means for a seal as claimed in claim 1 wherein the seal is a labyrinth seal.

7. Support means for a seal as claimed in claim 1 wherein a liner is provided between the bases of said members and said abradable lining.

8. Support means for a seal as claimed in claim 1 wherein said abradable lining is a honeycomb structure.
